(19) United States
(12) Patent Application Publication
(10) Pub. No.: US 2008/0177655 A1
(43) Pub. Date: Jul. 24, 2008

(54) SYSTEMS AND METHODS OF UNDERWRITING BUSINESS CREDIT

(76) Inventor: David Zalik, Atlanta, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/626,166

(22) Filed: Jan. 23, 2007

(51) Int. Cl. G06Q 40/00

(52) U.S. Cl. 705/38

(57) ABSTRACT

Various embodiments of the present invention provide systems and methods for underwriting an unsecured line of credit for a buyer using a buyer's trade credit score, and the unsecured line of credit can be used by the buyer to purchase goods and services from a plurality of sellers. In addition, various embodiments provide systems and methods of automatically approving higher credit limits for unsecured lines of credit as compared to known credit cards by considering the trade credit scores and the merits of the buyer's business. Furthermore, various embodiments provide negotiating flexibility for credit terms depending on the extent to which one or more sellers are willing to take on a portion of the risks associated with the line of credit or fund at least a portion of the costs of one or more credit terms associated with the line of credit.

### BACKGROUND OF THE INVENTION

Buyers (e.g., retailers) that purchase goods and/or services for resell from a seller (e.g., merchant) often need to finance the purchase of the goods and/or services. Currently, financing arrangements (e.g., a line of credit) may be provided by the seller to the buyer for purchases made from the seller, or the financing arrangements (e.g., a business credit card) may provided by a bank or other third party creditor to the buyer to finance purchases made by the buyer from a plurality of sellers.

In particular, in a financing arrangement between the seller and the buyer, the seller typically considers a trade credit score and a trade credit report for the buyer prior to issuing a line of credit to the buyer. The trade credit score and trade credit report are provided by one of several trade credit bureaus, such as Lyon or Coface. Because this type of financing arrangement is between two parties, it provides the seller with a degree of flexibility in setting the credit terms associated with a line of credit as well as determining the type of information to be used to approve the line of credit and the associated credit terms. However, in this type of financing arrangement, each seller bears the burden for collections, credit risk, and the cost of funding the credit for each buyer, and each buyer has to negotiate and enter into financing arrangements with each seller. Thus, this type of financing arrangement has high transaction costs for the seller and the buyers.

In addition, in a financing arrangement in which a banker or third party creditor issues a business credit card to the buyer, the banks typically consider the personal credit score (e.g., FICO) of an authorized signatory of the buyer and a business credit score (e.g., INTELLISCORE) of the buyer to determine the credit terms. Although business credit cards provide the advantage of being usable to make purchases at a plurality of sellers, the credit limits associated with business credit cards are typically small (e.g., up to about $20,000) as compared to the buyer-to-seller financing described above, which makes this type of financing unsuitable for buyers that need to buy large quantities of goods or services for resell. In addition, banks typically require a personal guarantee of the cardholder as a condition to issuing credit to the buyer. Furthermore, business credit cards typically have inflexible credit terms (e.g., credit limit, grace period, interest rate). The smaller credit limits and often inflexible credit terms are a result of the banks' efforts to keep credit processing transaction costs low by not considering factors that may more fully indicate the merits of the buyer's business.

Thus, a need in the art exists for a financing arrangement that allows buyers to purchase goods and services from a plurality of sellers while avoiding the high transaction costs of business-to-business trade credit and the limitations of business credit cards.

### BRIEF SUMMARY OF THE INVENTION

Various embodiments of the present invention provide systems and methods for underwriting an unsecured line of credit by a creditor for a buyer that can be used by the buyer to purchase goods and services from a plurality of sellers. According to various embodiments, the systems and methods provide efficient credit transaction processing that takes into account the merits of the buyer's business to offer higher credit limits and more favorable and flexible credit terms (e.g., interest rates or payment schedules). For example, in one embodiment, a higher credit limit (as compared to known unsecured credit cards) is automatically approved for the unsecured line of credit by considering the trade credit score of the buyer. In one embodiment, other information indicative of the merits of the buyer's business (e.g., business credit score and credit reports for the buyer, personal credit score of an authorized signatory of the buyer, or financial statements of the buyer) are considered with the trade credit score. According to another embodiment of the invention, the buyer has more negotiating flexibility with the credit terms offered to the buyer depending on the extent to which one or more sellers are willing to take on a portion of the credit risks associated with the line of credit or fund at least a portion of the costs of providing certain credit terms for the line of credit (e.g., pay at least a portion of the interest accrued for certain purchases to reduce the effective interest rate to the buyer or to lengthen the effective payment schedule for the buyer).

In particular, according to various embodiments of the invention, a method of underwriting an unsecured line of credit for a buyer is provided that includes the steps of: (1) receiving an application for an unsecured line of credit for a buyer that is usable for making purchases from a plurality of sellers; (2) retrieving a trade credit score associated with the buyer; (3) in response to retrieving the trade credit score of the buyer, comparing the trade credit score with a pre-established acceptable range of trade credit scores; (4) in response to the trade credit score of the buyer being within the pre-established acceptable range, approving the application; and (5) in response to approving the application, transmitting the approval to the buyer. In one embodiment, these steps may be performed automatically and/or in real time.

In various embodiments of the invention, the method further comprises the steps of: (1) comparing the trade credit score to a first range of trade credit scores that are associated with a first credit term; (2) in response to the trade credit score being within the first range of trade credit scores, approving the application with the first credit term; (3) in response to the trade credit score not being within the first range of trade credit scores, comparing the trade credit score to a second range of trade credit scores that are associated with a second credit term; and (4) in response to the trade credit score being within the second range of trade credit scores, approving said application with the second credit term. In one embodiment, the first and second credit terms are selected from a group consisting of: interest rates, grace periods, and credit limits.

As another example, in other various embodiments of the invention, a system of underwriting an unsecured line of credit for a buyer is provided that comprises a credit approval module and a credit account management module. The credit approval module is adapted for receiving an application for an unsecured line of credit for a buyer, retrieving a trade credit score for the buyer, comparing the trade credit score to a range of acceptable trade credit scores, and approving the application in response to the trade credit scores being within the range of acceptable trade credit scores. The credit account management module adapted for setting up an approved line of credit, receiving a request to make purchases against the line of credit, comparing a requested purchase amount with the line of credit, and in response to the line of credit being greater than or equal to the requested purchase amount, authorizing the purchase request.

Furthermore, various embodiments of the invention provide negotiating flexibility for credit terms depending on the extent to which one or more sellers are willing to take on a portion of the risks associated with the line of credit and/or fund at least a portion of the costs of providing certain credit terms for the line of credit. For example, according to various embodiments, a method of improving a credit limit associated with an unsecured line of credit for a buyer that is usable to make purchases from a plurality of sellers is provided. The method includes the steps of: (1) receiving a guarantee from at least one of a plurality of sellers in which the seller assumes at least a portion of the risk associated with the unsecured line of credit; and (2) in response to receiving the guarantee from the seller, improving the credit limit associated with the unsecured line of credit from a first credit limit to a second credit limit.

As another example, a creditor may adjust the interest rate or the payment schedule (e.g., grace period) that is charged to the buyer and is associated with the line of credit in response to a seller agreeing to fund at least a portion of the costs resulting from the adjustment. In particular, in one embodiment, the creditor may extend a payment schedule associated with the line of credit for the buyer from 60 days to 90 days in response to the seller agreeing to pay at least a portion of the interest accrued on the outstanding balance from the end of the initial 60 day payment schedule to the end of the 90 day payment schedule. In a particular embodiment, the seller may agree to pay only the portion of interest that is accrued on purchases made with the seller. Furthermore, in another embodiment, the creditor may reduce the effective interest rate to the buyer from a first interest rate to a second interest rate in response to the seller agreeing to pay at least a portion of the difference in the interest accrued on the outstanding balance under the first interest rate and the interest accrued on the outstanding balance under the second interest rate.

### BRIEF DESCRIPTION OF THE DRAWINGS

Having thus described the invention in general terms, reference will now be made to the accompanying drawings, which are not necessarily drawn to scale, and wherein:

FIG. 1 is a schematic diagram illustrating a system according to one embodiment of the invention.

FIG. 2 is a schematic diagram illustrating a credit management server according to one embodiment of the invention.

FIG. 3 is a flowchart illustrating an underwriting process according to one embodiment of the invention.

FIG. 4 is a flow diagram of a credit approval module according to one embodiment of the invention.

FIG. 5 is a flow diagram of a credit account management module according to one embodiment of the invention.

FIG. 6 is an exemplary application for a line of credit according to a particular embodiment of the invention.

FIG. 7 is a flowchart illustrating a credit limit approval process according to one embodiment of the invention.

FIG. 8 is a flowchart illustrating a credit account activation process according to one embodiment of the invention.

FIG. 9 is a flowchart illustrating a process for processing a purchase transaction against a line of credit according to one embodiment of the invention.

### DETAILED DESCRIPTION OF THE INVENTION

The present invention now will be described more fully with reference to the accompanying drawings, in which some, but not all embodiments of the invention are shown. Indeed, this invention may be embodied in many different forms and should not be construed as limited to the embodiments set forth herein. Rather, these embodiments are provided so that this disclosure will satisfy applicable legal requirements. Like numbers refer to like elements throughout.

As will be appreciated by one skilled in the art, the present invention may be embodied as a method, a data processing system, or a computer program product. Accordingly, the present invention may take the form of an entirely hardware embodiment, an entirely software embodiment, or an embodiment combining software and hardware aspects. Furthermore, the present invention may take the form of a computer program product on a computer-readable storage medium having computer-readable program instructions (e.g., computer software) embodied in the storage medium. More particularly, the present invention may take the form of web-implemented computer software. Any suitable computer-readable storage medium may be utilized including hard disks, CD-ROMs, optical storage devices, or magnetic storage devices.

The present invention is described below with reference to block diagrams and flowchart illustrations of methods, apparatuses (i.e., systems) and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

### Brief Overview

Various embodiments of the present invention provide systems and methods for underwriting a line of credit extended to a buyer. In particular, various embodiments provide systems and methods of underwriting an unsecured line of credit for a buyer that can be used by the buyer to purchase goods and services from a plurality of sellers. In addition, various embodiments provide systems and methods of automatically approving higher credit limits for unsecured lines of credit as compared to known credit cards by considering the trade credit score and other various criteria of the buyer. In one embodiment, other information indicative of the merits of the buyer's business (e.g., business credit score and credit reports, financial statements) are considered in addition to or instead of the trade credit score. For example, in one embodiment, a credit limit equal to about 80% of the value of goods sold by the buyer in a month may be automatically approved for the buyer depending on the buyer's trade credit score, business credit score, and/or the amount of credit extended by other creditors to the buyer in the past.

Furthermore, various embodiments provide negotiating flexibility for credit terms depending on the extent to which one or more sellers are willing to take on a portion of the risks associated with the line of credit or fund the costs of providing certain credit terms (e.g., payment schedules or interest rates) associated with the line of credit to the buyer. For example, the credit limit may be increased by a certain amount if a seller is willing to guarantee at least a portion of the increased amount of the credit limit. As another example, a payment schedule for paying at least a portion of a balance of a line of credit may be extended for the buyer if a seller is willing to pay a portion of the interest accrued on the balance for the time period between an initial payment schedule date and an extended payment schedule date.

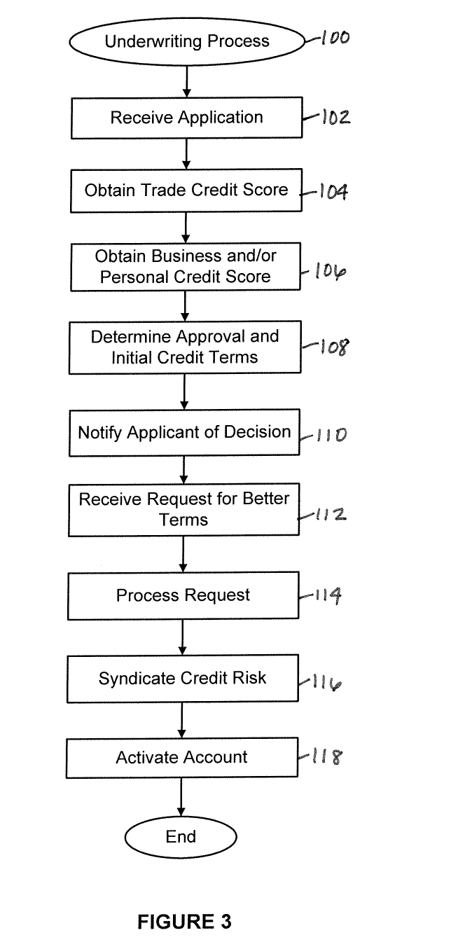

As shown in FIG. 3, an exemplary underwriting process 100 according to various embodiments of the invention begins with a creditor receiving an application for an unsecured line of credit from a buyer, shown as Step 102. The application may be received over a network (e.g., the Internet or other communication network), by phone, by mail, or by facsimile, for example, and the application may include information identifying the buyer, such as the name of the buyer, its primary address, trade or bank references, its federal tax identification number, and personal information about an authorized signatory for the buyer (e.g., name, address, and social security number).

Next, the creditor uses this information to assess the credit risk associated with the buyer, such as by retrieving a trade credit score associated with the buyer, a business credit score associated with the buyer, a personal credit score associated with an authorized signatory of the buyer, financial statements for the buyer, and/or references provided by banks, trade organizations, and trade partners of the buyer. For example, in one embodiment, the creditor obtains a trade credit score for the buyer from an appropriate trade credit bureau (e.g., Coface, Lyon), which is shown as Step 104. In one embodiment, the creditor also obtains a business credit score for the buyer (e.g., INTELLISCORE from Experian) and, in some embodiments, a personal credit score for an authorized signatory (e.g., FICO or VANTAGESCORE from Experian, Equifax, and/or TransUnion), as shown in Step 106. Although Step 104 is shown before Step 106 in the embodiment illustrated in FIG. 3, Step 106 can occur before Step 104 or they may occur simultaneously. In addition, the trade credit score, the business credit score, and the personal credit score may be obtained electronically or manually.

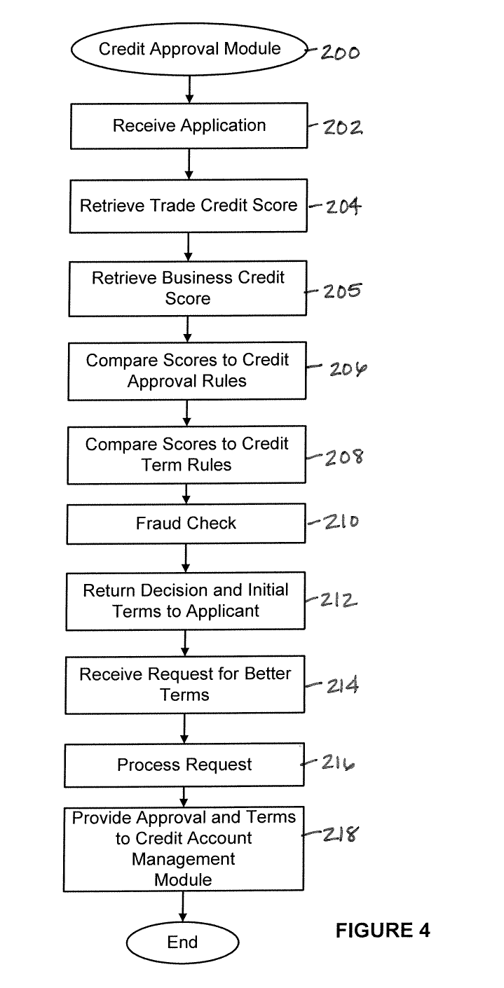

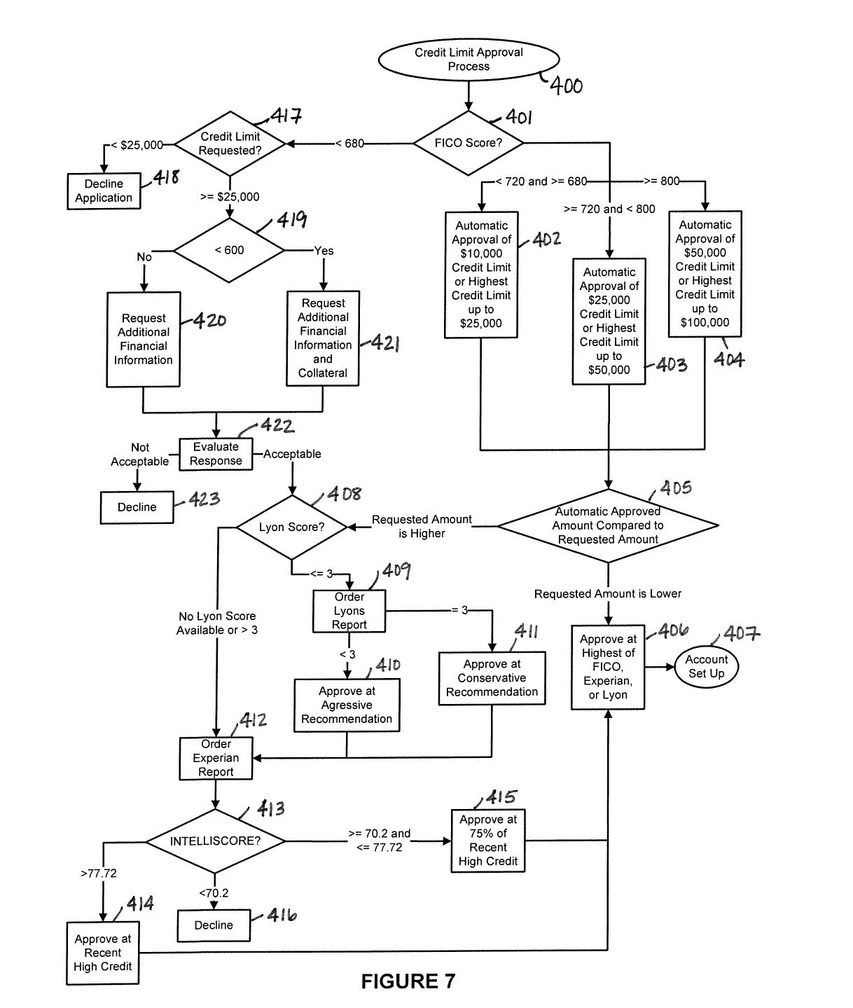

In response to obtaining the buyer's trade credit score and business credit score and the personal credit score of the authorized signatory, the creditor determines whether the application should be approved and the initial credit terms to be offered to the buyer, which is shown as Step 108. Various processes of determining credit approval and the initial credit terms according to various embodiments are described below in relation to FIGS. 4 and 7. In response to determining credit approval and the initial credit terms, the creditor notifies the buyer of the approval and the offer for the initial credit terms, which is shown as Step 110.

As shown in Step 112, in various embodiments, the creditor may receive a request from the buyer for particular credit terms, such as a higher credit limit, a lower interest rate, or a longer payment schedule (e.g., net 30 to net 60 days to pay the balance on the line of credit). The request may be received as part of the application in Step 102, or it may be sent after receiving the initial credit terms provided in Step 110. In response to receiving the request, the creditor processes the request to determine if the particular terms may be granted, shown as Step 114. The process of analyzing the request may include, for example, consideration of (1) trade credit scores, business credit scores, and/or personal credit scores, (2) financial statements from the buyer, (3) references provided by banks, trade organizations, or trade partners, (4) how much other lenders have lent to the customer over a certain time period, (5) information regarding the credit history of the buyer in a credit report, and/or (6) assets owned by the buyer that the buyer is willing to pledge as collateral to secure at least a portion of the line of credit. In addition, if a buyer is seeking to extend the payment schedule, a seller from whom the buyer seeks to purchase goods or services may pledge to pay at least a portion of the interest accrued during the time period initially offered until the end of the time period requested. Furthermore, if a buyer is seeking to increase its credit limit or lower the credit pricing (e.g., interest rate), the seller may agree to guarantee at least a portion of the credit limit or pay at least a portion of the interest accrued to the lower effective interest rate to the buyer. In another embodiment, the buyer may agree to an increased interest rate in exchange for an increased credit limit.

According to one embodiment, in Step 116, the credit risk (e.g., funding of the line of credit extended to the buyer) may be syndicated to local banks, financial institutions, distributors, or factors/credit insurers, for example.

Finally, in Step 118, if the application is approved and credit terms are agreed upon between the creditor and the buyer, the buyer's line of credit is activated, and the buyer can use the line of credit to make purchases at a plurality of sellers. Upon activation, in one embodiment, the buyer is provided a payment instrument (e.g., credit card or checks) associated with the line of credit to use when making purchases against the line of credit. In a particular embodiment, the payment instrument is a credit card that is co-branded with a well-known credit card company (e.g., MasterCard, VISA, American Express, Discover), and purchases made with the card are processed over the network corresponding with the co-branding credit card company. In addition, the embodiment in FIG. 3 shows Step 118 occurring after Steps 112, 114, and 116, but in other embodiments, this step may occur prior to or simultaneously with Step Steps 112, 114, or 116.

### System Architecture

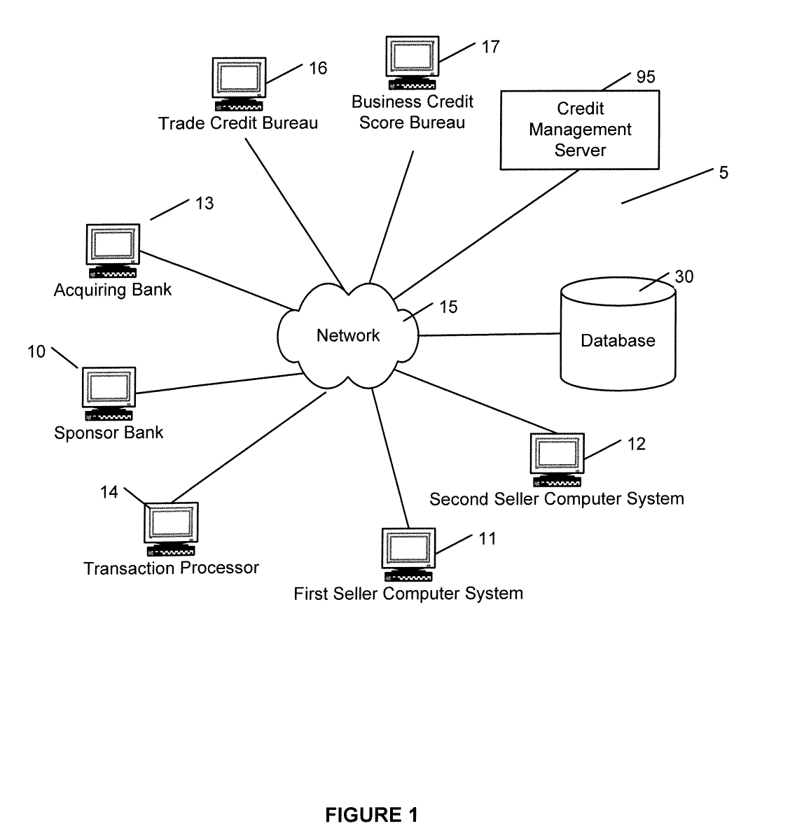

A system 5 according to one embodiment of the invention is shown in FIG. 1. As may be understood from this figure, in this embodiment, the system includes one or more seller computers 11, 12, a transaction processor computer 14, a sponsor bank computer 10, an acquiring bank computer 13, a trade credit bureau computer 16, and a business credit score bureau computer 17 that are connected, via a network 15 (e.g., a LAN, the Internet, private network and/or banking network), to communicate with a credit management system 95. In one embodiment of the invention, the credit management system 95 is configured for retrieving data from, and storing data to, a database 30 that may be stored on (or, alternatively, stored remotely from) the credit management system 95. In an alternative embodiment, the system 5 may include more than one database 30. In other embodiments, the credit management system 95 may be one or more computers or software programs running on one or more computers.

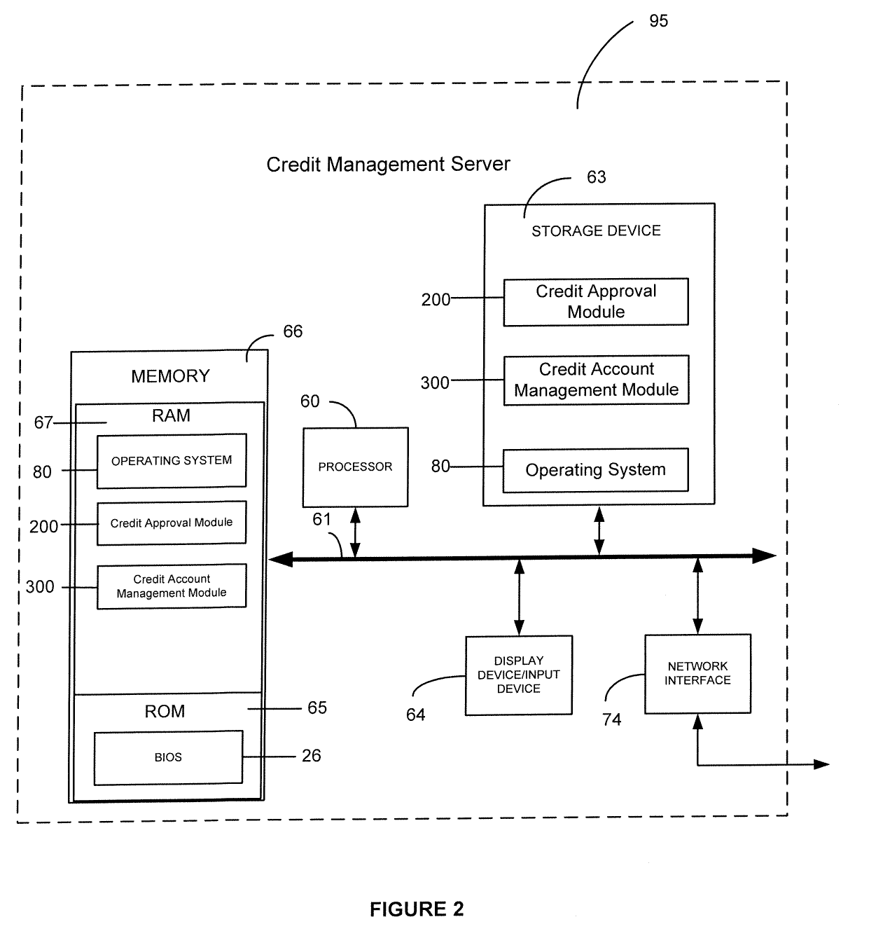

FIG. 2 shows a schematic diagram of a credit management system 95 according to one embodiment of the invention. The credit management system 95 includes a processor 60 that communicates with other elements within the computer system 95 via a system interface or bus 61. Also included in the system 95 is a display device/input device 64 for receiving and displaying data. This display device/input device 64 may be, for example, a keyboard or pointing device that is used in combination with a monitor. The system 95 further includes memory 66, which preferably includes both read only memory (ROM) 65 and random access memory (RAM) 67. The system's ROM 65 is used to store a basic input/output system 26 (BIOS), containing the basic routines that help to transfer information between elements within the system 95. Alternatively, the credit management system 95 can operate on one computer or on multiple computers that are networked together.

In addition, the system 95 includes at least one storage device 63, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 63 is connected to the system bus 61 by an appropriate interface. The storage devices 63 and their associated computer-readable media provide nonvolatile storage for a personal computer. It is important to note that the computer-readable media described above could be replaced by any other type of computer-readable media known in the art. Such media include, for example, magnetic cassettes, flash memory cards, digital video disks, and Bernoulli cartridges.

A number of program modules may be stored by the various storage devices and within RAM 67. For example, as shown in FIG. 2, program modules of the credit management system 95 include an operating system 80, a credit approval module 200 and a credit account management module 300. The credit approval module 200 and the credit account management module 300 control certain aspects of the operation of the credit management system 95, as is described in more detail below, with the assistance of the processor 60 and an operating system 80.

Also located within the system 95 is a network interface 74, for interfacing and communicating with other elements of a computer network. It will be appreciated by one of ordinary skill in the art that one or more of the system's 95 components may be located geographically remotely from other system 95 components. Furthermore, one or more of the components may be combined, and additional components performing functions described herein may be included in the systems 95.

### Exemplary System Operation

As mentioned above, the system 5 according to various embodiments enables creditors to provide more favorable financing arrangements to buyers by considering the trade credit score of each buyer and other factors related to the merits of each buyer in the credit underwriting process.

### Credit Approval Module

FIG. 4 illustrates a flow diagram of a credit approval module 200 according to various embodiments of the invention. Beginning at Step 202, the credit approval module 200 receives an application for credit. According to one embodiment, the application is received electronically (e.g., via email, XML, facsimile, text message (e.g., short message service (“SMS”), telephone, kiosk, or point of sale device at a seller location) over a communications network (e.g., Internet, private network). In an alternative embodiment, the information from the application may be entered manually into the system 5.

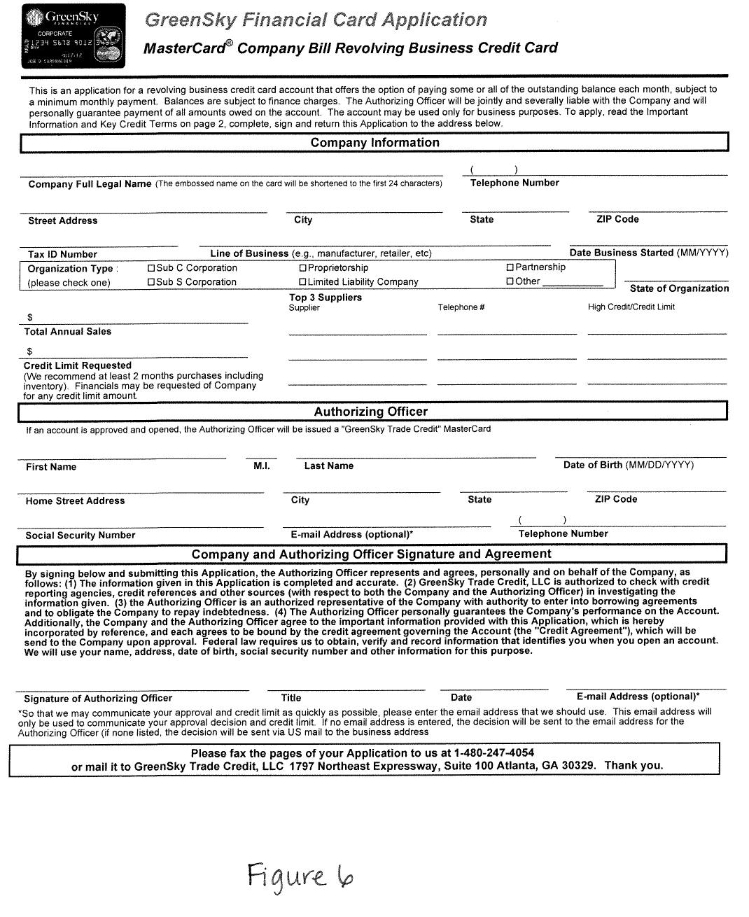

In addition, the application contains information identifying the buyer (e.g., name, primary address, federal tax identification number). According to a particular embodiment, FIG. 6 shows an exemplary application for a line of credit that includes the buyer's legal name, telephone number, street address, tax identification number, line or type of business of the buyer (e.g., retailer, manufacturer, importer), date on which the buyer's business was started, type of organization (e.g., S corporation, C corporation, proprietorship, limited liability company, partnership), state of organization, total annual sales, contact information for top three suppliers and credit limit extended to the buyer by each, credit limit requested from the creditor to whom the application is being submitted, and personal information of an authorizing officer of the buyer (e.g., name, address, date of birth, social security number, telephone number, email address).

Referring back to FIG. 4, in response to receiving the application, the credit approval module 200 retrieves at least one trade credit score associated with the buyer, shown as Step 204. According to various embodiments of the invention, the trade credit score may be retrieved from one or more of a plurality of trade credit bureaus, including Lyon, Coface, Experian, and Equifax. As an example, a Lyon trade credit score ranges from 1 to 7 (1 indicating the least credit risk and 7 indicating the most credit risk. In addition, according to a particular embodiment of the invention, the credit approval module 200 may be further configured for retrieving a trade credit score from a trade credit bureau that specializes in the particular line of business indicated in the application. For example, Lyon typically specializes in retailer-type businesses, and Coface typically specializes in importer-type businesses. In a further embodiment, the creditor may calculate its own trade credit score using financial information about the buyer provided by the buyer and/or included in business credit reports associated with the buyer or in personal credit reports associated with an authorized signatory for the buyer.

In a particular embodiment, the credit approval module 200 also retrieves at least one business credit score associated with the buyer, shown as Step 205. According to various embodiments, the credit approval module 200 may retrieve the business credit score (e.g., INTELLISCORE) associated with the buyer from Experian, Equifax, TransUnion, or Dun & Bradstreet, for example. As an example, an Experian INTELLISCORE provides an indication of the risk that a buyer will be more than 90 days delinquent on paying its debts within the next twelve months, and the scores range from 0 to 100, with lower scores indicating that the risk of the buyer being more than 90 days delinquent is very high and higher scores indicating that the risk of the buyer being more than 90 days delinquent is very low. In a further embodiment (not shown), the credit approval module 200 also retrieves at least one personal credit score (e.g., FICO, VANTAGESCORE) associated with an authorized signatory of the buyer from Experian, Equifax, or TransUnion, for example. As an example, the FICO scores typically range from 300-850, with 300 indicating the most credit risk and 850 indicating the least credit risk. The retrieved trade, business, and personal credit scores are stored in the database 30 according to a particular embodiment. In addition, although Step 204 is shown before Step 205 in the embodiment illustrated in FIG. 4, the credit approval module 200 may execute Step 205 before or at the same time as Step 204. Furthermore, the business and personal credit scores and the trade credit score may be retrieved electronically or manually.

In response to retrieving the trade credit score, the business credit score, and the personal credit score, the credit approval module 200 compares the scores to pre-determined credit approval rules specified by the creditor, shown as Step 206. For example, in a particular embodiment, the pre-determined credit approval rules specify that if the signatory's FICO personal credit score is less than about 680, then the buyer should be denied credit. In another embodiment, the pre-determined credit approval rules specify that if the signatory's FICO personal credit score is less than about 680, the buyer should be denied credit unless the buyer has a Lyon trade credit score that is less than or equal to about 3 or an Experian INTELLISCORE greater than or equal to about 70.2. Exemplary embodiments of pre-determined credit approval rules are discussed below in relation to Table 1 and FIG. 7. In addition, according to one embodiment, the pre-determined credit approval rules specify that an application should be denied if the buyer has declared bankruptcy, if public records or credit reports for the buyer indicate any tax liens, or if the buyer has overdrawn its bank account(s) over a certain number of times. In various embodiments, the pre-determined credit approval rules may be changed depending on the preferences of the creditor.

In response to determining that the application should be approved, the credit approval module 200 compares the trade credit score, the business credit score, and/or the personal credit score to pre-determined credit term approval rules to determine the credit terms to be offered to the buyer, shown as Step 208. For example, in a particular embodiment of the invention, the credit approval module 200 compares the trade credit score to a first range of trade credit scores and the business credit score to a first range of business credit scores. The first range of trade credit scores and the first range of business credit scores are associated with a first credit term. If the trade credit score falls within the first range of the trade credit scores or if the business credit score falls within the first range of business credit scores, the first credit term is associated with the line of credit. However, if the scores fall outside of the first ranges, the scores are compared to second ranges of scores associated with a second credit term. If the scores do not fall within the second ranges of scores, then the credit approval module 200 continues to compare the scores with ranges of scores associated with alternative credit terms until a match is found. In one embodiment, the credit terms may be a credit limit, credit pricing, and/or a payment schedule.

In another embodiment, the credit approval module 200 determines a first credit limit based on a trade credit score (e.g., by comparing the trade credit score to pre-determined credit term approval rules), a second credit limit based on a business credit score (e.g., by comparing the business credit score to pre-determined credit term approval rules), and a third credit limit substantially equal to the highest unsecured credit limit extended to the buyer by another creditor (e.g., as shown in a credit report for the buyer or on the buyer's financial statements), and the highest of the first, second, and third credit limits is associated with the line of credit for the buyer.

Tables 2 and 3 and FIG. 7, which are discussed in detail below, illustrate exemplary pre-determined credit term approval rules that consider the FICO score, Lyon score, and Experian INTELLISCORE for the buyer according to various embodiments of the invention.

In addition, according to various other embodiments, credit terms may be determined by considering: (1) a trade credit score, (2) a business credit score, (3) a personal credit score for an authorized signatory of the buyer, (4) financial statements from the buyer, (5) references provided by banks, trade organizations, or trade partners, (6) how much other lenders have lent to the buyer with a particular time period (e.g., past year, past 6 months, past month), (7) assets owned by the buyer that the buyer is willing to pledge as collateral, and/or (8) whether one or more sellers are willing to take on a portion of the risks associated with the line of credit and/or fund at least a portion of the costs of providing certain credit terms associated with the line of credit to the buyer. According to other embodiments, the credit limit may be based on the percentage of sales, profits, or goods purchased over a defined time period, and in a particular embodiment, this information is provided by the buyer from financial statements.

For example, in one embodiment, the credit limit for the line of credit is set at a certain percentage of the amount of goods sold by the buyer within a particular time period (e.g., a month, 3 months, 6 months, a year). For example, the credit limit may be set at between about 80% and 100% of the value of goods purchased within a month. In another embodiment, the credit limit for the line of credit is set at a certain percentage of the value of goods sold (e.g., between 5% and 20% of the value of goods sold annually) or the revenue earned by the buyer within a particular time period (e.g., between 2% and 20% of the buyer's annual revenue). In a further embodiment, the credit limit associated with the line of credit for the buyer may determined by comparing (e.g., determining the average limit, the highest limit, the lowest limit, or the mean limit) the credit limits yielded by an analysis of the trade credit score, the business credit score, the highest unsecured credit limit extended to the buyer by another creditor, and/or the percentage of goods sold, revenue earned, or goods purchased over the particular time period.

In addition, the embodiment in FIG. 4 shows Step 208 occurring after Step 206, but these steps may occur substantially at the same time in other embodiments.

In response to comparing the credit scores of the buyer to the pre-determined credit term approval rules, the credit approval module 200 proceeds to Step 210 to perform a fraud check on the application. Although Step 210 is shown as occurring after Step 208, Step 210 may be performed prior to or simultaneously with any of Steps 204-208.

In response to the fraud check in Step 210 confirming that the application does not appear to be fraudulent, the credit approval module 200 generates a message to the buyer (or an authorized signatory) informing the buyer of the line of credit approval and associated credit terms, shown as Step 212. The message may be communicated manually, or it may be transmitted electronically over a network, such as via email, facsimile, XML, text message (e.g., SMS), telephone, or display on a computer screen, kiosk, or a point-of-sale device at a seller location. In another embodiment, Step 210 may occur after Step 212, such as when the approval message is a preliminary approval pending the results of the fraud check.

According to various embodiments, the buyer can request better terms than those originally offered by the creditor or those requested by the buyer in the original application. In particular, a request from the buyer for more favorable terms is received by the credit approval module 200 at Step 214, and the request is processed in Step 216. Step 216, according to various embodiments, may include considering (1) the credit scores, (2) financial statements from the buyer (e.g., showing value of goods purchased, value of goods sold, or profits earned), (3) references provided by banks, trade organizations, or trade partners, (4) how much other lenders have lent to the customer over a certain time period (e.g., past month, past 6 months, or past year), and (5) assets owned by the buyer that the buyer is willing to pledge as collateral for at least a portion of the line of credit. In addition, the credit approval module 200 may consider whether one or more sellers from whom the buyer seeks to purchase goods or services are willing to take on at least a portion of the risks or costs associated with the line of credit (e.g., by agreeing to guarantee at least a portion of the credit limit extended to the buyer) and/or fund at least a portion of the costs of providing certain credit terms (e.g., by agreeing to pay a portion of the interest accrued on the outstanding balance of the line of credit). As an example, a buyer may request that the interest rate associated with the line of credit (or for a particular transaction made with the line of credit) be lowered, and a seller may agree to pay at least a portion of the difference of the interest accrued at the lower interest rate requested and the interest accrued at the initial, higher interest rate offered to the buyer. In addition, the buyer may request that the payment schedule associated with the line of credit be extended from a first payment date to a second payment date, and a seller may agree to pay at least a portion of the interest accrued on the balance between the first payment date and the second payment date, according to one embodiment. Furthermore, in another embodiment, the seller may limit its agreement to fund at least a portion of the costs of the new credit term (e.g., interest rate and/or payment schedule) for the portion of the balance resulting from purchases made from the seller.

As another example, according to a particular embodiment, the buyer may request a higher credit limit. In response, according to one embodiment, the credit approval module 200 compares a requested credit limit with a guideline upper credit limit associated with a trade credit score for the buyer, and in response to the requested credit limit being less than or equal to the guideline credit limit associated with the trade credit score, approves the application for a credit limit that is between the requested credit limit and the guideline upper credit limit associated with the trade credit score. For example, if the buyer is initially approved for a credit limit of $65,000 and the buyer requests that the credit limit be raised to $80,000, the credit approval module 200 retrieves the current trade credit score for the buyer. If the trade credit score is 2 and the guideline credit limit associated with a trade credit score of 2 is $75,000, the credit approval module 200 sets the credit limit at a value between about $75,000 and about $80,000.

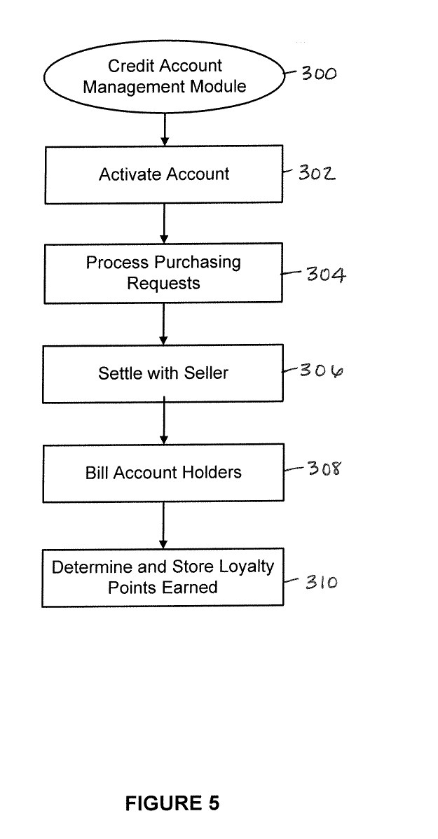

Upon determining the credit terms for the line of credit, the credit approval module 200 provides the approval and credit terms to the credit account management module 300 to set up the new line of credit (or update an existing line of credit), shown as Step 218. The credit account management module 300 is discussed below in relation to FIG. 5. In addition, the embodiment shown in FIG. 4 illustrates Steps 214 and 216 occurring prior to Step 218, but in other embodiments, Steps 214 and 216 may occur after Step 218.

Referring back to Step 206, in accordance with a particular embodiment of the invention, Table 1 below illustrates a set of pre-determined credit approval rules listing criteria upon which approval may be based. For example, approval may be based on (1) a trade credit score (e.g., obtained from Lyon), a business credit score (e.g., INTELLISCORE obtained from Experian), or the buyer's authorized signatory's personal credit score (e.g., FICO score obtained from Experian, Equifax, or TransUnion), (2) a combination of two or more scores, or (3) a combination of two or more scores and consideration of additional information about the buyer submitted to the creditor. Additional information may include, for example, balance sheets, profit and loss statements, income statement for prior year(s), bank statements, or credit reports.

TABLE 1
Pre-Determined Credit Approval Rules

| | | Lyon Score/Experian INTELLISCORE | |
|---|---|---|---|
| | | 1–3/>70.2 | N/A or 4+/<70.2 |
| FICO Score | >680 | Approve | Approve based on |
| | | | FICO |
| | 600–680 | Approve based on | Decline |
| | | Lyon Score or | |
| | | Experian Score | |
| | <600 | Approve based on | Decline |
| | | successful review of | |
| | | additional information | |
| | | provided by applicant | |
| | | (unless Lyon Score is | |
| | | 3 or less, then Decline) | |

In addition, referring back to Step 208, according to a particular embodiment, Table 2 illustrates a set of pre-determined credit term approval rules listing criteria upon which credit terms may be determined automatically. For example, credit terms may be determined by consideration of (1) a trade credit score obtained from Lyon, the buyer's INTELLISCORE business credit score obtained from Experian, or the buyer's signatory's FICO personal credit score, (2) a combination of two or more scores, or (3) a combination of two or more scores and consideration of additional information submitted to the creditor. According to the embodiment shown in Table 2, the credit limit offered to the buyer is the highest credit limit yielded by the FICO score, Lyon score, and Experian INTELLISCORE.

TABLE 2
Pre-Determined Credit Term Approval Rules for a Credit Limit

| Type of Score | Score | Credit Limit |
|---|---|---|
| FICO | >680 | Minimum $10k or max limit of another |
| | | unsecured limit up to $25k |
| | >720 | Minimum $25k or max limit of another |
| | | unsecured limit up to $50k |
| | >800 | Minimum $40k or max limit of another |
| | | unsecured limit up to $100k |
| Lyon Score | 1 or 2 | Aggressive Lyon recommendation |
| | 3 | Conservative Lyon recommendation |
| Experian | >70.2 | 75% of recent high credit (unsecured) |
| INTELLISCORE | >77.72 | 100% of recent high credit (unsecured) |

For example, if a buyer has a FICO score of 700, a Lyon score of 2, and an Experian INTELLISCORE of 77.5, then the credit approval module 200 considers whether the aggressive Lyon recommendation (e.g., provided in a Lyon credit report) or 75% of the recent high unsecured credit extended to the buyer by another creditor (e.g., provided in a credit report, in application, or in financial statements) is higher than a minimum of $10,000 (the credit limit yielded by a FICO score of 700). If not, then the credit limit offered to the buyer is $10,000. However, if the aggressive Lyon recommendation or 75% of the recent high unsecured credit extended to the buyer by another creditor is higher than $10,000, then the highest of these options is the credit limit offered to the buyer. In one embodiment, the highest of these options may be limited in part by a maximum credit limit allowed for a certain FICO score, such as by offering the highest credit limit yielded by the Lyon score and/or the INTELLISCORE up to $25,000 (maximum credit limit yielded by a FICO score of 700).

In addition to determining a credit limit to be offered to the buyer, the credit approval module 200 utilizes the buyer's trade credit score and business credit score to determine credit pricing according to various embodiments of the invention. In accordance with one embodiment, the credit approval module 200 utilizes the set of rules set forth in Table 3 below to determine an interest rate to be offered to the buyer.

TABLE 3
Pre-Determined Credit Term Approval Rules for Credit Pricing

| | Prime + 3.75% | Prime + 9.75% | Prime + 15.75% |
|---|---|---|---|
| FICO | >720 | 680–720 | <680 |
| Lyon Score | 1 | >1 | >2 |
| Experian Intelliscore | >77.72 | 70.2–77.72 | <70.2 |

According to one embodiment, if only one of the three types of scores for the buyer is available, the credit approval module 200 determines the interest rate based on the available score. In one embodiment, the interest rate offered may depend on the credit limit requested by the buyer. For example, if two or more types of scores are available, then the least favorable score is used to determine the interest rate if the credit limit requested by the buyer is less than $20,000. As another example, if the credit limit requested by the buyer is greater than or equal to $20,000, the most favorable score is used to determine the interest rate. For example, if the buyer requests a credit limit of $25,000 and has a FICO score of 735 and a Lyon score of 2, the interest rate offered to the buyer is prime plus 3.75%. However, if the buyer requests a credit limit of $19,000 and has a FICO score of 735 and a Lyon score of 2, the interest rate offered to the buyer is prime plus 9.75%.

According to various embodiments, the buyer is given a payment schedule (e.g., grace period) in which to pay at least a portion of the outstanding balance of the line of credit without being charged interest. In one embodiment, the time period is 30 days. However, in other embodiments, the time period may be one month, 45 days, or 60 days, for example. In a particular embodiment, the credit approval module 200 may indicate that the time period is 30 days if the buyer elects to receive loyalty points or 60 days if the buyer elects to not receive loyalty points for purchases made. As discussed in more detail below, according to various embodiments, the credit account management module 300 stores any loyalty points accumulated by the buyer and processes requests by the buyer to redeem the points for various goods or services.

According to various embodiments, the credit approval module 200 may also retrieve credit reports for the buyer depending on the credit score(s) retrieved. For example, the credit approval module 200 according to one embodiment may request an Experian credit report if the Lyon score is unavailable. In another example, the credit approval module 200 may request a Lyon and an Experian report if the Lyon score is greater than or equal to two. In addition, in one embodiment, the credit approval module 200 may request additional information from the buyer if the Lyon score is between 2 and 4. Furthermore, in one embodiment, if the buyer's signatory's FICO score is between about 600 and about 680 and the amount of credit requested by the buyer is above $25,000, the credit approval module 200 may request additional information from the buyer. In addition, if the FICO score is below about 600 and the amount of credit requested is above $25,000, the credit approval module 200 may further request additional information from the buyer and a security deposit or a pledge of business assets as security for at least a portion of the credit limit requested.

FIG. 7 illustrates an exemplary process of comparing credit scores to pre-determined credit rules to determine approval and a credit limit according to a particular embodiment. The process 400 begins with the credit approval module 200 determining whether the FICO score for the buyer's authorized signatory is greater than or equal to 680, shown as Step 401. If the FICO score is greater than or equal to 680 and less than 720, then the credit approval module 200 automatically approves the line of credit for a credit limit that is the higher of $10,000 or the highest unsecured credit extended to the buyer by another creditor up to $25,000, shown as Step 402. If the FICO score is greater than or equal to 720 and less than 800, then the credit approval module 200 automatically approves the line of credit for a credit limit that is the higher of $25,000 or the highest unsecured credit extended to the buyer by another creditor up to $50,000, shown as Step 403. If the FICO score is greater than or equal to 800, then the credit approval module 200 automatically approves the line of credit for a credit limit that is the higher of $50,000 or the highest unsecured credit extended to the buyer by another creditor up to $100,000, shown as Step 404.

Next, the credit limit automatically approved for the line of credit based on the FICO score is compared to the credit limit requested in the credit application, shown as Step 405. If the requested credit limit is lower than the credit limit determined using the FICO score, then the application is approved at the credit limit determined using the FICO score, which is shown as Step 406. If the requested credit limit is higher than the credit limit determined using the FICO score, then the credit approval module 200 considers the trade credit score of the buyer, such as the Lyon score, shown as Step 408. For example, in the embodiment shown in FIG. 7, if the trade credit score obtained from Lyon is greater than 3 or if Lyon does not have a record for the buyer, then the credit approval module 200 retrieves a credit report for the buyer from a business credit bureau, such as Experian, shown as Step 412. However, if the Lyon trade credit score is less than or equal to 3, then the credit approval module 200 retrieves the Lyon report for the buyer, shown as Step 409. If the Lyon score is less than 3, then the credit approval module 200 automatically approves the credit limit of the line of credit at the Lyon Aggressive Recommendation in the Lyon report, shown as Step 410. If the Lyon score is equal to 3, then the credit approval module 200 automatically approves the credit limit of the line of credit at the Lyon Conservative Recommendation in the Lyon report, shown as Step 411. Next, the credit approval module 200 proceeds to Step 412.

Upon ordering the Experian Report in Step 412, the credit approval module 200 determines whether the Experian INTELLISCORE report for the buyer is greater than 77.72, between 70.2 and 77.72, or less than 70.2, shown as Step 413. If the INTELLISCORE is greater than 77.72, then the credit approval module 200 automatically approves the credit limit of the line of credit at the highest credit limit extended to the buyer within a specified time frame (e.g., last 6 months or last year), which is shown as Step 414. If the INTELLISCORE is less than or equal to 77.72 and greater than or equal to 70.2, then the credit approval module 200 automatically approves the credit limit of the line of credit at 75% of the highest credit limit extended to the buyer within a specified time frame (e.g., last 6 months or last year), which is shown as Step 415. If the INTELLISCORE is less than 70.2, then the credit approval module 200 declines the application, which is shown as Step 416.

After the highest credit limits have been determined using the FICO score, the Lyon trade credit score, and the Experian INTELLISCORE, the credit approval module 200 approves the credit application at the highest credit limit for which the line of credit has been automatically approved by the credit application module 200 in Steps 401-415, which is shown as Step 406. Upon approval of the credit limit for the line of credit, the line of credit account for the buyer is set up by the credit account management module 300, which is shown as Step 407.

Referring back to Step 401, if the FICO score is less than 680, the credit approval module 200 considers whether the credit limit requested by the buyer is greater than or equal to $25,000. If not, the application is declined, shown as Step 418. If the requested credit limit is greater than $25,000, then the credit approval module 200 determines whether the FICO score is less than 600. If the FICO score is greater than or equal to 600, then the credit approval module 200 requests that the buyer submit additional financial information for consideration by the creditor, shown as Step 420. If the FICO score is less than 600, then the credit approval module 200 requests that the buyer submit additional financial information for consideration by the creditor and pledge collateral for at least a portion of the credit limit, shown as Step 421. The response from the buyer is evaluated by the credit approval module 200 in Step 422, and if acceptable, the credit approval module proceeds to Step 408 to consider the Lyon score of the buyer. If the response from the buyer is not acceptable, the credit approval module 200 declines the application, shown as Step 423. In another embodiment, the response from the buyer may be considered manually by the creditor.

The embodiment of the process shown in FIG. 7 specifically considers the FICO score, the Lyon trade credit score, and the Experian INTELLISCORE, but in various other embodiments, other credit scores may be considered in determining a credit limit to associate with a line of credit. In addition, in various other embodiments, the ranges for the credit scores and the ranges of automatically approved credit limits may vary depending on the preferences of the creditor.

Furthermore, in various embodiments, one or more authorized signatories may be associated with the buyer's line of credit. For example, these signatories may be issued payment instruments upon activation of the line of credit. In one embodiment, the credit approval module 200 retrieves a personal credit score associated with the one or more authorized signatories and compares the personal credit score of each signatory to a range of pre-determined acceptable personal credit scores. If the personal credit score of each signatory is within the range of acceptable personal credit scores, the credit approval module 200 approves each signatory to receive a payment instrument associated with the line of credit or otherwise have access to the line of credit.

### Credit Account Management Module

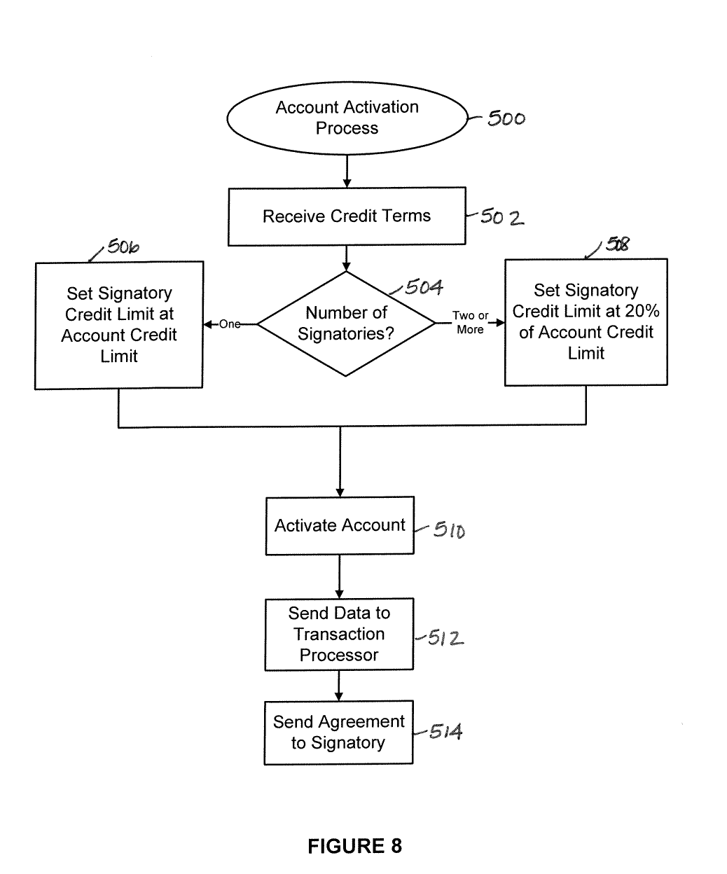

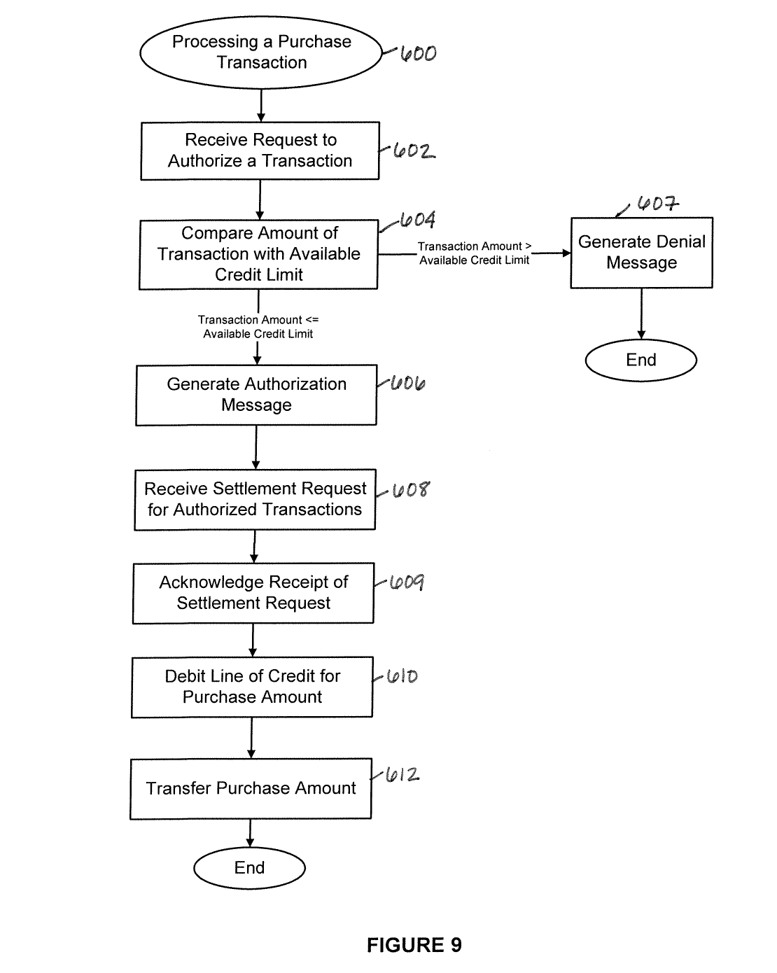

According to various embodiments and illustrated in FIG. 5, the credit account management module 300 activates the line of credit for the buyer upon approval of the application and agreement on the credit terms, shown as Step 302 and discussed in more detail in relation to FIG. 8. In addition, the credit account management module 300 processes purchasing requests from the buyer, shown as Step 304, and the credit account management module 300 settles with sellers from whom the buyer made purchases, shown as Step 306. Steps 304 and 306 are discussed below in more detail in relation to FIG. 9.

The credit account management module 300 also bills account holders for purchases made using the line of credit, shown as Step 308. For example, the creditor may bill the buyer bimonthly, monthly, every 30 days, or every 60 days. According to various embodiments, the bills may be presented to the buyer in a format specified by the buyer. In addition, the bills may be transmitted to the buyer manually or electronically.

Furthermore, the credit account management module 300 according to various embodiments of the invention, determines the number of loyalty points earned by a buyer or authorized signatory from purchases made against the line of credit and stores the loyalty points earned, which is shown at Step 310.

FIG. 8 illustrates a process of activating an account for a buyer according to various embodiments of the invention. In particular, the process 500 begins at Step 502 by receiving and storing the buyer's information and the credit terms approved for the buyer from the credit approval module 200. Next, the credit management module 300 determines whether the buyer has requested payment instruments (e.g., cards, checks, or fobs) for one signatory or multiple signatories, shown as Step 504. If the buyer has requested a payment instrument for one signatory, then the credit limit for the signatory is set to be substantially equal to the credit limit for the line of credit, shown as Step 506, according to one embodiment. If the buyer has requested a payment instrument for more than one signatory, then the credit limit for each signatory is set at a percentage of the credit limit for the line of credit or at a particular value, according to one embodiment. In a further embodiment, the credit limit for each signatory is set at the higher amount of the percentage or particular value, provided that the total of the credit limits for the signatories is less than or equal to a certain percentage of the credit limit associated with the line of credit. For example, according to a particular embodiment shown in Step 508, the credit limit for each signatory is set at about 20% of the credit limit for the line of credit or at about $5,000, whichever is higher provided that the total of the credit limits for the signatories is less than or equal to about 20% of the credit limit associated with the line of credit. Upon determining the credit limits associated with each signatory in Steps 504-508, the line of credit is activated at Step 510, and a signatory agreement and final disclosure are transmitted to each signatory at Step 514. The signatory agreement and final disclosure may be transmitted manually via mail, courier, or in person, or the agreement and disclosure may be transmitted electronically via electronic mail, facsimile, post to a webpage, text message (e.g., SMS), or telephone message. In a particular embodiment in which the transaction processor 14 maintains the account limits for each account, the data for each signatory is transmitted to the transaction processor 14 at Step 512.

FIG. 9 illustrates a process of processing purchasing transactions according to various embodiments of the invention. In particular, the process 600 begins at Step 602 with the receipt by the credit account management module 300 of a request to authorize a purchase made against the line of credit, for example by presenting a payment card or other payment instrument associated with the line of credit. In one embodiment, the request is forwarded to the credit account management module 300 from the transaction processor 14, which receives the request from the seller 11, 12 via the network 15. According to various embodiments, the network 15 may be a private network or a network maintained by a payment card brand (e.g., MasterCard, VISA, American Express, or Discover). In addition, according to various embodiments, the authorization request includes a purchase amount, the identity of a signatory making the purchase (e.g., identified by a number on a payment instrument, a name on the payment instrument, or an account number associated with the line of credit), and the identity of a seller making the authorization request (e.g., a seller identification code or the seller's name).

Next, in Step 604, the credit account management module 300 compares the amount requested to an available credit limit associated with the signatory. As shown in Step 606, if the requested amount does not exceed the available credit limit, the credit account management module 300 generates an authorization message for transmitting to the seller 11, 12 via the transaction processor 14, according to various embodiments. If the requested amount exceeds the available credit limit, the credit account management module 300 generates a denial message for transmitting to the seller 11, 12, which is shown as Step 607. In addition, in embodiments in which a particular authorized signatory is not associated with the line of credit, the requested amount is compared to the available credit limit associated with the buyer's line of credit.

In one embodiment, after the goods are shipped from the seller 11, 12 to the signatory or the buyer, the transaction processor 14 receives a request for settlement from the seller 11, 12 for the authorized transactions, and the transaction processor 14 transmits the request to the credit account management module 300 for payment, shown as Step 608. In response to receiving the request for settlement, the credit account management module 300 acknowledges the request is received (Step 609), debits the line of credit for the purchase amount (Step 610), and transfers the funds for the purchase amount to the transaction processor 14 (Step 612). According to various embodiments, the request for settlement is received periodically (e.g., daily, every 48 hours, weekly, etc.) as a batch file from the transaction processor 14 and/or from the seller 11, 12 (or sellers' banks). In addition, in a further embodiment, the funds transferred in Step 612 are for all purchases that are listed in the batch file. In other embodiments, the request for settlement may be received by the credit account management module 300 directly from the seller 11, 12, and the credit account management module 300 may transfer the funds for settlement to the seller 11, 12 directly. Furthermore, FIG. 9 describes a process of processing a purchase transaction against a line of credit according to one embodiment, but this process may occur according to other methods that are well-known to one of skill in the art.

In addition, in various embodiments, Step 612 further includes transferring the funds for the purchase amount less a transaction fee charged by the creditor. In one embodiment, this transaction fee may be comparatively less than transaction fees charged by other creditors in the industry (e.g., between about 0.2% and 0.5%) or the fees may be greater than or substantially equal to transaction fees charged by other creditors in the industry (e.g., between about 0.5% and about 5%). In a particular embodiment in which a seller agrees to take on a portion of the risks associated with the line of credit or fund a portion of the costs for certain credit terms associated with the line of credit, the payment instrument associated with the line of credit may be co-branded as between the seller and the creditor, and the creditor may share a portion of the transaction fees with the seller. The transaction fees shared, according to various embodiments, may be transaction fees earned from purchases made from one or more sellers (e.g., including the co-branding seller) or from purchases made from the co-branding seller only.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended listing of inventive concepts. Although specific terms are employed herein, they are used in a generic and descriptive sense only and not for purposes of limitation.

1. A method of underwriting an unsecured line of credit for a buyer, said method comprising the steps of:
receiving an application for an unsecured line of credit for a buyer, said credit line usable for making purchases from a plurality of sellers;
retrieving a trade credit score associated with said buyer;
in response to retrieving said trade credit score of said buyer, comparing said trade credit score with a pre-established acceptable range of trade credit scores;
in response to said trade credit score of said buyer being within said pre-established acceptable range, approving said application; and
in response to approving said application, transmitting said approval to said buyer.

2. The method of claim 1 further comprising the steps of:
retrieving a business credit score associated with said buyer;
in response to retrieving said business credit score, comparing said business credit score with a pre-established acceptable range of business credit scores; and
in response to said business credit score being within said pre-established acceptable range of said business credit scores, approving said application.

3. The method of claim 1 further comprising the steps of:
retrieving a personal credit score associated with an authorized signatory of said buyer;
in response to retrieving said personal credit score, comparing said personal credit score with a pre-established acceptable range of personal credit scores; and
in response to said personal credit score being within said pre-established acceptable range of said personal credit scores, approving said application.

4. The method of claim 1 further comprising the steps of:
retrieving a business credit score associated with said buyer and a personal credit score associated with an authorized signatory of said buyer;
in response to retrieving said business credit score and said personal credit score, comparing said business credit score with a pre-established acceptable range of business credit scores and comparing said personal credit score with a pre-established acceptable range of personal credit scores; and
in response to said business credit score being within said pre-established acceptable range of said business credit scores, said personal credit score being within said pre-established acceptable range of said personal credit scores, and said trade credit score being within said pre-established range of said trade credit scores, approving said application.

5. The method of claim 1 wherein said step of approving said application comprises:
comparing said trade credit score to a first range of trade credit scores, said first range of trade credit scores being associated with a first credit term;
in response to said trade credit score being within said first range of trade credit scores, approving said application with said first credit term;
in response to said trade credit score not being within said first range of trade credit scores, comparing said trade credit score to a second range of trade credit scores, said second range of trade credit scores being associated with a second credit term; and
in response to said trade credit score being within said second range of trade credit scores, approving said application with said second credit term.

6. The method of claim 5 wherein said first and second credit terms comprise one or more of interest rates, payment schedules, or credit limits.

7. The method of claim 1 further comprising the steps of:
retrieving a business credit score associated with said buyer;
determining a first credit limit based on said business credit score;
determining a second credit limit based on said trade credit score; and
associating the higher of the first and second credit limits with said line of credit.

8. The method of claim 7 further comprising the steps of:
retrieving a personal credit score associated with an authorized signatory of said buyer;
determining a third credit limit based on said personal credit score; and
associating the highest of the first, second, and third credit limits with said line of credit.

9. The method of claim 1 further comprising the steps of:
retrieving a business credit score associated with said buyer;
determining a first credit limit based on said business credit score;
determining a second credit limit based on said trade credit score;
determining a third credit limit substantially equal to the highest unsecured credit limit extended to said buyer by another creditor; and
associating the highest of the first, second, and third credit limits with said line of credit.

10. The method of claim 9 further comprising the steps of:
retrieving a personal credit score associated with an authorized signatory of said buyer;
determining a fourth credit limit based on said personal credit score; and
associating the highest of the first, second, third, and fourth credit limits with said line of credit.

11. The method of claim 1 wherein said unsecured line of credit is associated with a credit limit, and wherein said method further comprises the step of determining said credit limit based on the amount of goods sold by said buyer within a particular time period.

12. The method of claim 1 wherein said unsecured line of credit is associated with a credit limit, and wherein said method further comprises the step of determining said credit limit based on the amount of goods purchased by said buyer within a particular time period.

13. The method of claim 1 wherein said unsecured line of credit is associated with a credit limit, and wherein said method further comprises the step of determining said credit limit based on profits earned by said buyer within a particular time period.

14. The method of claim 1 wherein said application for credit comprises a requested credit limit, and said method further comprises the steps of:
comparing said requested credit limit with a guideline upper credit limit associated with said trade credit score for said buyer; and
in response to said requested credit limit being less than or equal to said guideline upper credit limit for said trade credit score, approving said application for an amount between said requested credit limit and said guideline upper credit limit associated with said trade credit score.

15. The method of claim 14 wherein said guideline upper credit limit is a first guideline upper credit limit and said method further comprises the step of comparing said trade credit score with a second guideline upper credit limit associated with said trade credit score in response to said requested credit limit being greater than said first guideline upper credit limit; and
in response to said requested credit limit being less than or equal to said second guideline credit limit, approving said application for an amount between said requested credit limit and said second guideline credit limit.

16. The method of claim 15 wherein said method further comprises the step of requesting additional financial information associated with said buyer in response to said requested credit limit being greater than said guideline upper credit limit associated with said trade credit score.

17. The method of claim 14 wherein said method further comprises the step of requesting additional financial information associated with said buyer in response to said requested credit limit being greater than said guideline upper credit limit.

18. The method of claim 14 wherein said application for credit further comprises a requested credit limit, and said method further comprises the steps of:
retrieving a business credit score associated with said buyer;
comparing said requested credit limit with a guideline upper credit limit associated with said business credit score;
in response to said requested credit limit being less than or equal to said guideline upper credit limit associated with said business credit score or said trade credit score, approving said application for an amount between said requested credit limit and the lower of said guideline upper credit limits associated with said business credit score and said trade credit score.

19. The method of claim 14 wherein said application for credit further comprises a requested credit limit, and said method further comprises the steps of:
retrieving a personal credit score associated with an authorized signatory of said buyer;
comparing said requested credit limit with a guideline upper credit limit associated with said personal credit score;
in response to said requested credit limit being less than or equal to said guideline upper credit limit associated with said personal credit score or said trade credit score, approving said application for an amount between said requested credit limit and the lower of said guideline upper credit limits associated with said personal credit score and said trade credit score.

20. The method of claim 1 wherein said unsecured line of credit is associated with a credit limit, and wherein said method further comprises the step of improving said credit limit if a seller agrees to guarantee at least a portion of an outstanding balance on said line of credit.

21. The method of claim 1 wherein said unsecured line of credit is associated with a payment schedule for a buyer to make a payment towards an outstanding balance on said line of credit, and wherein said method further comprises the step of increasing said payment schedule for said buyer from a first payment schedule to a second payment schedule in response to a seller agreeing to pay at least a portion of interest accrued on said outstanding balance between an end of said first payment schedule and an end of said second payment schedule.

22. The method of claim 1 wherein said unsecured line of credit is associated with an interest rate paid by the buyer, and wherein said method further comprises the step of decreasing said interest rate paid by the buyer from a first interest rate to a second interest rate in response to a seller agreeing to pay at least a portion of a difference between interest accrued on an outstanding balance of said line of credit under said first interest rate and interest accrued on said outstanding balance under said second interest rate.

23. The method of claim 1 wherein said unsecured line of credit is associated with a payment schedule for making a payment towards an outstanding balance on said line of credit, and wherein said method further comprises the step of shortening said payment schedule from a first payment schedule to a second payment schedule in response to said buyer electing to earn loyalty points based on purchases made against said line of credit.

24. The method of claim 1 wherein at least a portion of said unsecured line of credit is associated with an interest rate and a credit limit, wherein said method further comprises increasing said interest rate in response to receiving a request authorized by said buyer to increase said credit limit.

25. The method of claim 1 wherein said step of retrieving said trade credit score associated with said buyer includes retrieving a plurality of trade credit scores associated with said buyer.

26. The method of claim 1 wherein said application for credit comprises a type of business associated with said buyer, and wherein said step of retrieving said trade credit score for said buyer comprises identifying a trade credit source specializing in said type of business associated with said buyer and retrieving said trade credit score from said identified trade credit source.

27. The method of claim 1 wherein said application comprises an identity of an authorized signatory for said buyer, and said method further comprises the steps of:
retrieving a personal credit score associated with said authorized signatory;
comparing said personal credit score associated with said authorized signatory with a range of pre-established acceptable personal credit scores; and
in response to said personal credit score associated with said authorized signatory being within a range of pre-determined acceptable personal credit scores, approving said authorized signatory to receive a payment instrument associated with said line of credit.

28. The method of claim 27 wherein a signatory credit limit is associated with said signatory, said signatory credit limit being substantially equal to a credit limit associated with said line of credit.

29. The method of claim 27 wherein said application comprises identities of a plurality of authorized signatories, and wherein a signatory credit limit is associated with each signatory and each of said signatory credit limits is less than or substantially equal to a credit limit associated with said line of credit.

30. A system of underwriting an unsecured line of credit for a buyer, said system comprising:
a credit approval module adapted for receiving an application for a line of credit for a buyer, retrieving a trade credit score for said buyer, comparing said trade credit score to a range of acceptable trade credit scores, and approving said application in response to said trade credit scores being within said range of acceptable trade credit scores; and
a credit account management module adapted for setting up an approved line of credit, receiving a request to make purchases against said line of credit, comparing a requested purchase amount with said line of credit, and in response to said line of credit being greater than or equal to said requested purchase amount, authorizing said purchase request,
wherein said unsecured line of credit is usable for making purchases form a plurality of sellers.

31. The system of claim 30 wherein said application is received by said credit approval module electronically over a communication network.

32. The system of claim 30 wherein said credit account management module is further adapted for billing a seller for interest accrued on at least a portion of an outstanding balance of said line of credit.

33. The system of claim 30 wherein said credit approval module is further adapted for retrieving from a credit report a highest amount of unsecured credit extended to said buyer by a creditor and setting a credit limit associated with said line of credit to be substantially equal to said highest amount.

34. The system of claim 30 wherein said credit approval module is further adapted for:
retrieving a business credit score for said buyer,
determining a first guideline credit limit associated with said business credit score, a second guideline credit limit associated with said trade credit score, and a third guideline credit limit associated with a highest amount of unsecured credit extended to a buyer by a creditor;
comparing said first, second, and third guideline credit limit; and
associating a highest of said first, second, and third guideline credit limit with said line of credit as a credit limit for said line of credit.

35. The system of claim 34 wherein said credit approval module is further adapted for:
retrieving a personal credit score for an authorized signatory of said buyer,
determining a fourth guideline credit limit associated with said personal credit score;
comparing said first, second, third, and fourth guideline credit limits; and
associating a highest of said first, second, third, and fourth guideline credit limits with said line of credit as a credit limit for said line of credit.

36. The system of claim 30 wherein said unsecured line of credit is associated with a payment schedule for said buyer to make a payment towards an outstanding balance on said line of credit, and wherein said credit approval module is further adapted for increasing said payment schedule for said buyer from a first payment schedule to a second payment schedule in response to a seller agreeing to pay at least a portion of interest accrued on said outstanding balance between an end of said first payment schedule and an end of said second payment schedule.

37. The system of claim 30 wherein said credit approval module is further adapted for:
retrieving from said buyer an amount of goods sold by said buyer within a certain time period;
associating a percentage of said amount of goods sold as a credit limit for said line of credit.

38. The system of claim 30 wherein said credit approval module is further adapted for:
retrieving from said buyer an amount of profits earned by said buyer within a certain time period;
associating a percentage of said amount of profits earned as a credit limit for said line of credit.

39. The system of claim 30 wherein said credit approval module is further adapted for:
retrieving from said buyer an amount of goods purchased by said buyer within a certain time period;
associating a percentage of said amount of goods purchased as a credit limit for said line of credit.

40. A method of improving a credit limit associated with an unsecured line of credit for a buyer, said unsecured line of credit being usable to make purchases from a plurality of sellers, said method comprising the steps of:
receiving a guarantee from at least one of said plurality of sellers in which said at least one seller assumes at least a portion of the risk associated with said unsecured line of credit; and
in response to receiving said guarantee from said at least one seller, increasing a credit limit associated with said unsecured line of credit from a first credit term to a second credit limit.

41. A method of improving a credit term associated with an unsecured line of credit for a buyer, said unsecured line of credit being usable to make purchases from a plurality of sellers, said method comprising the steps of:
receiving a promise from at least one of said plurality of sellers in which said at least one seller promises to pay at least a portion of interest accrued on an outstanding balance of said line of credit;
in response to receiving said promise, improving said credit term for said buyer from a first credit term to a second credit term.

42. The method of claim 41 wherein said first credit term is a first payment schedule and said second credit term is a second payment schedule, said first payment schedule being shorter than said second payment schedule, and said step of receiving said promise from said seller comprises said seller agreeing to pay said at least a portion of interest accrued on an outstanding balance of said unsecured line of credit between an end of said first payment schedule and an end of said second payment schedule.

43. The method of claim 42 wherein said at least a portion of said outstanding balance is less than or substantially equal to an amount of said outstanding balance resulting from purchases made from said seller.

44. The method of claim 41 wherein:
said first credit term is a first interest rate and said second credit term is a second interest rate, said first interest rate being higher than said second interest rate, and
said step of receiving said promise from said seller comprises said seller agreeing to pay at least a portion of a difference between an amount of interest accrued on at least a portion of an outstanding balance of said line of credit under said first interest rate and an amount of interest accrued under said second interest rate.

45. The method of claim 44 wherein said at least a portion of said outstanding balance is less than or substantially equal to an amount of said outstanding balance resulting from purchases made from said seller.
